(19) United States
(12) Patent Application Publication
(10) Pub. No.: US 2004/0106397 A1
(43) Pub. Date: Jun. 3, 2004

(54) Mobile phone having function of forwarding recorded call data

(75) Inventors: Norikazu Yamagishi, Yokohama-shi (JP); Takaaki Habara, Yokohama-shi (JP); Mutsuharu Takesada, Yokohama-shi (JP); Makoto Horikawa, Yokohama-shi (JP); Shunichiro Hoshi, Yokohama-shi (JP); Mina Imai, Yokohama-shi (JP)

Correspondence Address: Christopher J. Fildes, Fildes & Outland, P.C., Suite 2, 20916 Mack Avenue, Grosse Pointe Woods, MI, 48236, US

(73) Assignee: Hitachi Electronic Service Co. Ltd.

(21) Appl. No.: 10/457,687

(22) Filed: Jun. 9, 2003

(30) Foreign Application Priority Data
Dec. 2, 2002 (JP) 2002-349656

(51) Int. Cl. H04M 3/42

(52) U.S. Cl. 455/417; 455/414.1

(57) ABSTRACT

A mobile phone 1 comprises an overall control unit 11, a transmission/reception unit 12, a display unit 13, an operation unit 14, a voice input/output unit 15, an address unit 16, a call recording unit 17, a unit 18 for forwarding recorded call data, a data editing unit 19, a unit 20 for presetting forwarding telephone number, a database control unit 21, a database 22, and a power unit 23, wherein the mobile phone is further provided with a function of registering the forwarding telephone number, recording the contents of the call in chronological order for each of the designated communication counterpart, and forwarding all or a selected portion of the contents of the recorded call to a designated forwarding destination when needed.

### FIELD OF THE INVENTION

The present invention relates to a mobile phone provided with a function of forwarding recorded call data. For example, the present invention relates to a mobile phone provided with a function of forwarding recorded call data for recording to the mobile phone the contents of a call made between a service person who is offering service in his/her workplace and the customers. In this example, the mobile phone of the present invention records the content of a call for each of the customer in chronological order in the mobile phone, forwards the recorded information to a phone set in a service center when requested, so that the service center can record and aggregate the information, and use and manage the information properly.

### DESCRIPTION OF THE RELATED ART

Conventionally, a mobile phone is often provided with a function of recording the contents of a call. However, since the calls are not recorded to correspond to individual communication counterparts, it is inconvenient for the user to play back and listen to the recorded contents.

### SUMMARY OF THE INVENTION

The present invention aims to provide a mobile phone having a function of designating a communication counterpart, recording the contents of the call in chronological order for each of the designated communication counterparts, and forwarding the contents of the call to a designated forwarding destination (for example, a manager) when needed.

In order to achieve the object mentioned above, the present mobile phone provided with a function of forwarding recorded call data comprises an overall control unit 11, a transmission/reception unit 12, a display unit 13, an operation unit 14, a voice input/output unit 15, an address book 16, a call recording unit 17, a unit 18 for forwarding recorded call information, an information editing unit 19, a unit 20 for presetting forwarding telephone number, a database control unit 21, a database 22, and a power unit 23, and is further provided with a function of recording the contents of the call in chronological order for each of the designated communication counterpart, and forwarding all or a selected portion of the contents of the recorded call to a designated forwarding destination.

Also, the mobile phone according to the present invention is further provided with a function of registering a forwarding telephone number.

Further, the mobile phone according to the present invention is provided with a function of checking the forwarding telephone number upon receiving a forwarding request from the forwarding destination.

Still further, the mobile phone according to the present invention is provided with a function of reading out the contents of the recorded call and forwarding the contents to the forwarding destination, upon receiving forwarding request from the forwarding destination.

Still further, the mobile phone according to the present invention is provided with a function of forwarding to said forwarding destination a number of the readout contents specified by the forwarding destination or all of the readout contents.

Moreover, the mobile phone according to the present invention is provided with a function of interrupting the forwarding or replaying action when requested during transferring, and a function of continuing forwarding or replaying action from the point of interruption.

Further, the mobile phone according to the present invention is provided with a function of skipping a content being forwarded or replayed at present and forwarding or replaying a subsequent content when requested during forwarding.

Still further, the mobile phone according to the present invention is provided with a function of forwarding or replaying a content from the beginning when requested.

### BRIEF DESCRIPTION OF THE DRAWINGS

FIG. 1 is a block diagram of a configuration of a mobile phone having a function of forwarding recorded call data;

FIG. 2 is an explanatory view showing an example of an embodiment of the present mobile phone in use;

FIG. 3 is a flow chart illustrating the process for designating the forwarding destination (base) for forwarding the content of the recorded call;

FIG. 4 is a flow chart illustrating the process carried out by the worker; and

FIG. 5 is a flow chart indicating the process that can be prosecuted at the base.

### DETAILED DESCRIPTION OF PREFERRED EMBODIMENTS

The preferred embodiment of the present invention will be explained below with reference to the drawings.

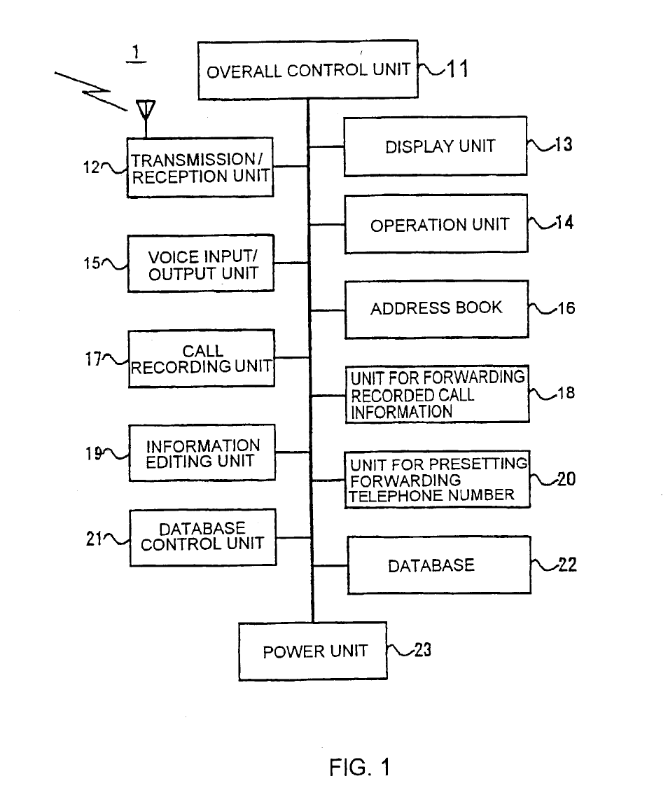

FIG. 1 is a block diagram explaining the configuration of the mobile phone provided with a function of forwarding recorded call information.

The mobile phone 1 of the present invention is provided with an overall control unit 11, a transmission/reception unit 12 for communicating with other machines, a display unit 13, an operation unit 14, a voice input/output unit 15, an address book 16, a call recording unit 17 for recording call data, a unit 18 for forwarding recorded call data, a data editing unit 19, a unit 20 for presetting forwarding telephone number, a database control unit 21, a database (hereinafter referred to as DB) 22, a power source 23, and the like.

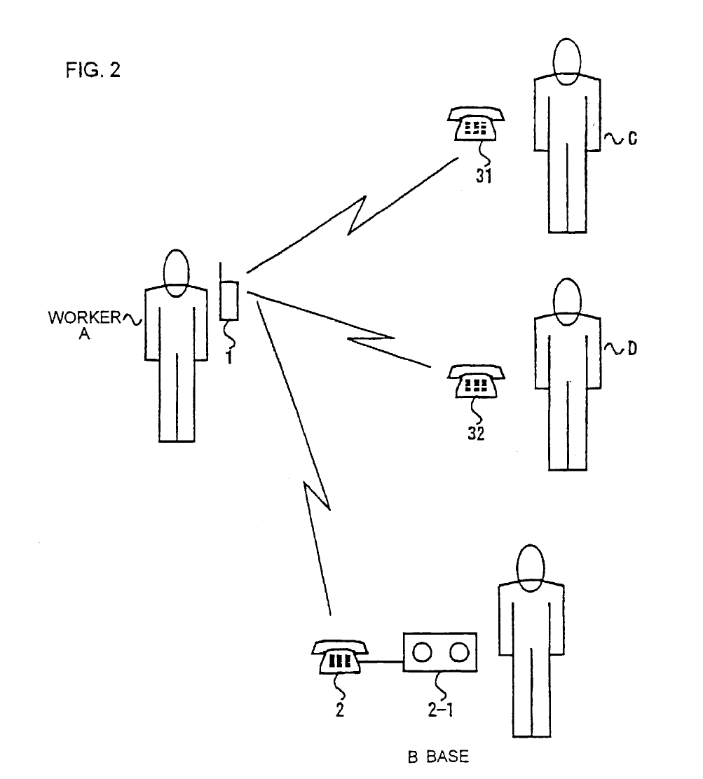

FIG. 2 is an explanatory view showing an example of an embodiment of the present mobile phone in use.

Reference A is a worker (for example, a serviceperson) carrying the mobile phone 1 according to the present invention. The worker A uses the mobile phone 1 to communicate with a plurality of customers (reference C, D, and soon) via a plurality of telephone sets (31, 32, and so on), records the contents of the calls in chronological order for each of the customers (reference C, D, and so on), and forwards the content of the call to a designated forwarding number of a telephone set 2 in a base B when necessary. Reference B is a base to which calls are forwarded (for example, a service center where managers work), and is equipped with the telephone set 2 and a recorder 2-1 connected thereto.

One or more forwarding telephone numbers are registered to the DB of the mobile phone in advance. The telephone unit 2 of the base B receives the contents of the above-mentioned calls forwarded from the mobile phone 1 of the worker A and records the same through the recorder 2-1, aggregates the recorded contents of the call, and utilizes or manages the contents of the calls made between each of the workers and each of the customers.

The mobile phone of the present invention is provided with functions mentioned below:

a function of recording the contents of the call for each of the designated communication counterpart in chronological order;

a function of registering the forwarding telephone number;

a function of selecting all or a portion of the contents of the recorded call, and forwarding the same to the forwarding destination;

a function of checking the forwarding telephone number upon receiving forwarding request from the forwarding destination; and

a function of reading out the contents of the recorded call and forwarding the same upon receiving forwarding request from the forwarding destination.

Also, the present mobile phone is equipped with functions listed below:

a function of reading out the contents of the recorded call, and forwarding all or a number of calls specified by the forwarding destination to the forwarding destination;

a function of interrupting forwarding or replaying operation of the contents when requested during forwarding, and a function of continuing from the point where forwarding or replaying operation was interrupted;

a function of skipping to the next content during forwarding or replaying operation when requested during forwarding; and

a function of forwarding or replaying from the beginning upon request.

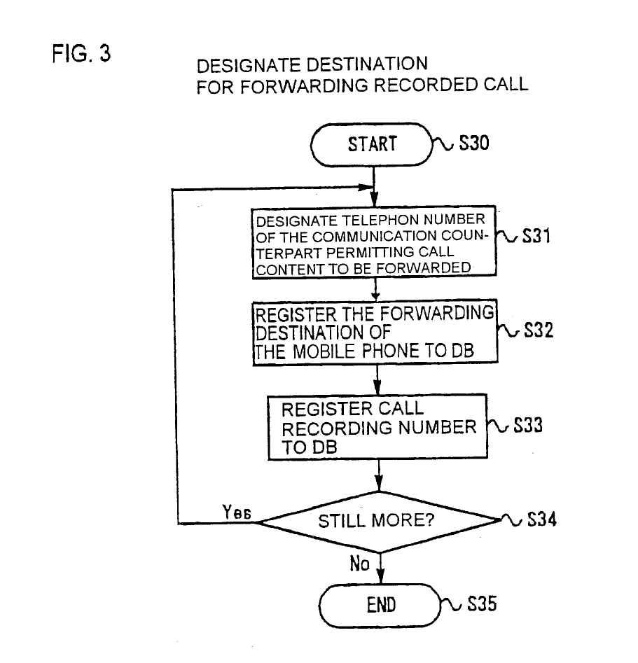

FIG. 3 is a flowchart indicating the process for designating the destination for forwarding the recorded call (designating the forwarding destination (base) for forwarding the contents of the recorded call, or designating the communication counterpart (customer)).

The process starts instep S30. In step S31, the telephone number of the communication counterpart (customer) permitting call content to be forwarded is designated. In step S32, the designated telephone number is registered to the forwarding destination DB (communication counterpart DB) in the mobile phone. The call recording number (reference numbers provided to correspond to customers, such as reference 01 for customer A, 02 for customer B, and the like) is registered in step S33 to the forwarding destination DB (communication counterpart DB). In step S34, it is determined whether there are “still more” to be registered or not. If there are, the process returns to step S31. If not, the process is completed in step S35.

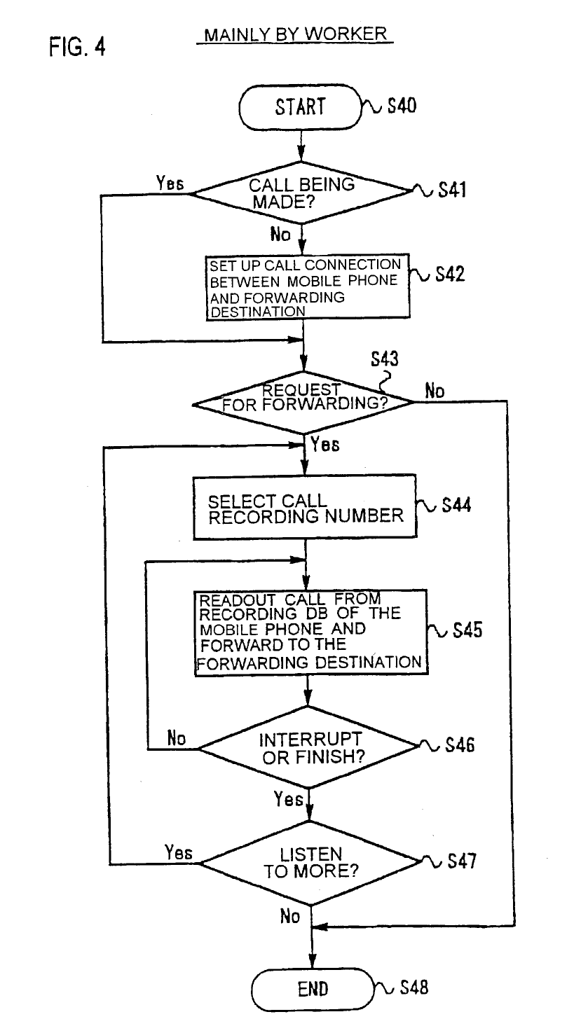

FIG. 4 is a flow chart indicating the process carried out by the worker.

The process starts in step S40. In step S41, it is determined whether a call is being made or not. If not, then in step S42 the mobile phone calls up the telephone set in the forwarding destination (base), and proceeds to step S43. If a call is being made, then in step S43 it is determined whether there is a request for forwarding. If not, then the process is completed in step S48. If there is, then in step S44 the call recording number (the reference number provided to correspond to a customer, such as 01 for customer A, 02 for customer B, and the like) is selected. In step S45, there corded call content corresponding to the call recording number is read out from the recording DB of the mobile phone, and is forwarded to the telephone set of the forwarding destination (base).

In step S46, it is determined whether to “interrupt or finish ” or not. If the answer is “no”, then the process of step S45 is continued. If the answer is “yes”, then in step 47 it is determined whether to “listen to more”. If the answer is yes, then the process returns to step S44. If there is no need to listen to more, then the process is completed in step S48.

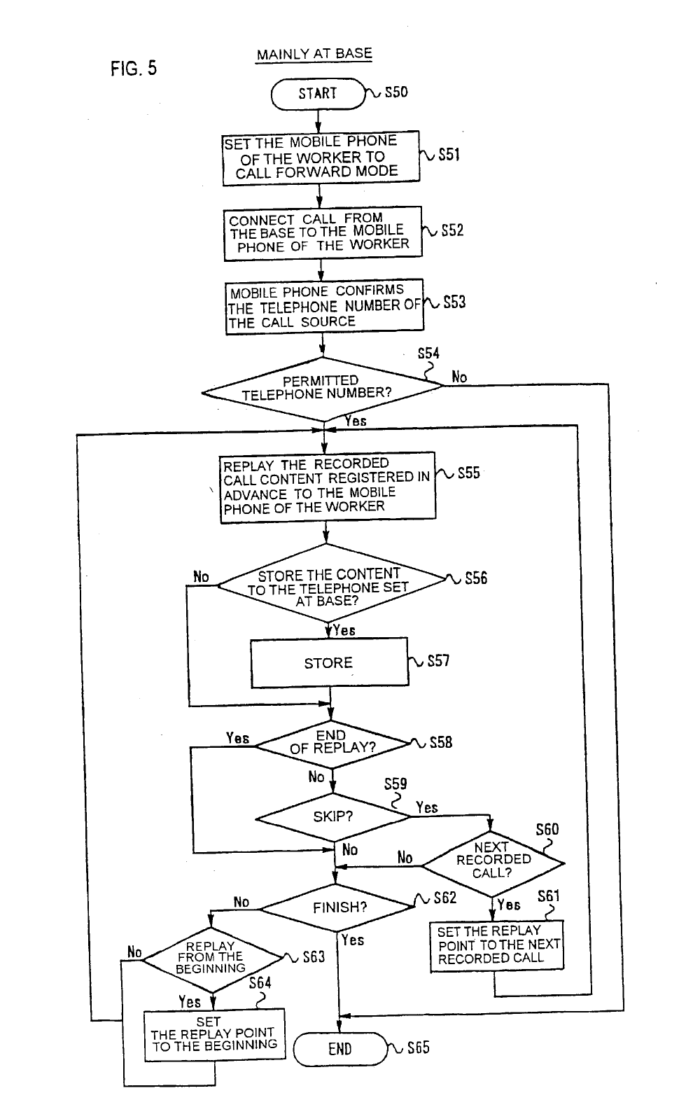

FIG. 5 is a flow chart indicating the process carried out mainly at the base.

The process starts in step S50. In step S51, the mobile phone of the worker is set to call forward mode, and the call is made in step S52 from the base to the mobile phone of the worker. In step S53, the mobile phone of the worker confirms the telephone number of the call being made, and determines in step S54 if it is the permitted telephone number (forwarding telephone number registered to the mobile phone) or not. If not, then the process proceeds to step S65 and ends the process. If it is so, then in step S55 the recorded call content registered to the mobile phone of the worker is replayed (forwarded).

In step S56, it is determined whether to store the replayed recorded call content to the recorder of the telephone set at the base or not. The call content is recorded (stored or recorded) in step S57. In step S58, it is determined whether to finish replaying or not. If so, the process proceeds to step S62. If not, then in step S59 it is determined whether to skip the content. If the content is not skipped, then the process proceeds to step S62. If the content is skipped, then in step S60 it is determined whether there is a next recorded call or not. If there is no more recorded call, then the process proceeds to step S62. If there is, then in step S61 the replay point is set to the next recorded call, and the process returns to step S55.

In step S62, it is determined whether to “finish” the process or not. If not, then it is determined in step S63 whether to start replaying from the beginning or not. If there is no need for replay, then the process returns to step S55. If there is need for replay, then in step S64 the replay point is set back to the beginning, and the process returns to step S55. If the answer in step S62 is yes, then the process is completed in step S65.

According to the present invention, the contents of the call made by a worker (for example, a service person) to a customer during working hour is recorded to the mobile phone per each of the customers in chronological order. Therefore, the contents of the recorded call for each of the customer can be replayed later. Moreover, by forwarding the content to a telephone set in a base (for example, a service center) according to need, the contents of these recorded call forwarded from each of the worker can be recorded and aggregated at the base, and can be used or managed appropriately.

We claim:

1. A mobile phone having a function of forwarding recorded call data, comprising an overall control unit, a transmission/reception unit, a display unit, an operation unit, a voice input/output unit, an address unit, a call recording unit, a unit for forwarding recorded call data, a data editing unit, a unit for presetting forwarding telephone number, a database control unit, a database, and a power unit,
wherein said mobile phone is further provided with a function of recording contents of a call in chronological order for each of a designated communication counterpart, and forwarding all or a selected portion of said contents of said recorded call to a forwarding destination.

2. A mobile phone having a function of forwarding recorded call data, wherein said mobile phone is further equipped with a function of recording contents of a call in chronological order for each of a designated communication counterpart, and forwarding all or a selected portion of said contents of said call to a forwarding destination.

3. A mobile phone having a function of forwarding recorded call data according to claim 1 or claim 2, wherein said mobile phone is further provided with a function of registering a forwarding telephone number.

4. A mobile phone having a function of forwarding recorded call data according to claim 3, wherein said mobile phone is further provided with a function of checking said forwarding telephone number upon receiving a forwarding request from said forwarding destination.

5. A mobile phone having a function of forwarding recorded call data according to claim 3 or claim 4, wherein said mobile phone is further provided with a function of reading out said contents of the recorded call, and forwarding said contents to said forwarding destination, upon receiving a forwarding request from said forwarding destination.

6. A mobile phone having a function of forwarding recorded call data according to claim 5, wherein said mobile phone is further provided with a function of forwarding a number of said readout contents specified by said forwarding destination or all of said readout contents to said forwarding destination.

7. A mobile phone having a function of forwarding recorded call data according to any one of claims 3 through 6, wherein said mobile phone is further provided with a function of interrupting forwarding or replaying operation when requested during forwarding, and a function of continuing forwarding or replaying from point of interruption.

8. A mobile phone having a function of forwarding recorded call data according to any one of claims 3 through 6, wherein said mobile phone is further provided with a function of skipping a content being forwarded or replayed, and starting forwarding or replaying a subsequent content when requested during forwarding.

9. A mobile phone having a function of forwarding recorded call data according to any one of claims 3 through 6, wherein said mobile phone is further provided with a function of forwarding or replaying a content from beginning when requested.
